(19) United States
(12) Patent Application Publication
(10) Pub. No.: US 2026/0290655 A1
(43) Pub. Date: Sep. 24, 2026

(54) Lead-Through for an Electrical Conductor

(71) Applicant: Daimler Truck AG, Leinfelden-Echterdingen (DE)

(72) Inventor: Fatih UYSAL, Plochingen (DE)

(21) Appl. No.: 19/475,908

(22) PCT Filed: Apr. 4, 2024
(86) PCT No.: PCT/EP2024/059265

§ 371 Date: Oct. 16, 2025

(30) Foreign Application Priority Data
Apr. 17, 2023 (DE) 10 2023 109 630.3

(51) Int. Cl. H01B 17/30; H01B 1/02; H01B 3/12; H05B 1/02

(52) U.S. Cl. CPC H01B 17/301; H01B 1/02; H01B 3/12; H05B 1/0236

(57) ABSTRACT

A lead-through for an electrical conductor where the electrical conductor is leadable out of a housing of an exhaust-gas system and where the electrical conductor is configured to lead a component out of the housing in an insulated manner. The lead-through is configured such that a temperature gradient is formed over a length of the electrical conductor such that a temperature of the electrical conductor is lowered within the lead-through.

### BACKGROUND AND SUMMARY OF THE INVENTION

The invention relates to a lead-through for an electrical conductor, wherein the electrical conductor can be led out of a housing of an exhaust-gas system.

Such electrical conductors can be designed for connecting an electrical heating device. Such a heating device is arranged, for example, in an exhaust gas tract so that a desired temperature threshold above which pollutants entrained in the exhaust gas can be converted effectively can be reached more quickly.

A lead-through for an electrical conductor is known from DE 10 2014 218 983 B4, wherein this lead-through is used for connecting an electrically heatable heating pane. The lead-through has an internal conductor which is led into insulation and an outer sleeve. The insulation is made from a porous ceramic layer having at least two layers.

DE 10 2021 209 264 B3 describes a more general lead-through of an electrical conductor, wherein the insulation is made from a glass ceramic having a volume resistivity.

In general, high temperatures develop in the electrical conductor within the lead-through. Therefore, the electrical conductor or an electrode cannot be contacted using commercially available plug connectors, as these do not withstand the high temperatures. A current load may be up to 320 A, for example. Commercially available plug connectors cannot be used for such high current loads and the high temperatures that occur in the process, in particular in an exhaust gas box environment in which temperatures of around 200° C. prevail

Furthermore, the electrical conductor that is led out should be fully insulated, so that short circuits with surrounding components, such as a housing in the exhaust gas tract, in particular an exhaust gas box, can be avoided. For example, short circuits caused by water, spray water, ice formation, dirt, oils/grease, fuel and other external influences, which can lead to a short circuit between the current-conducting component and the box housing, should be avoided. It is especially important, for example, to comply with the Agreement concerning the International Carriage of Dangerous Goods by Road (ADR) requirement which prescribes protection from short circuits.

Furthermore, the lead-through should be designed to be substantially tight so that exhaust gases cannot escape.

A further requirement of such lead-throughs results from the fact that the electrical conductor should be protected from dirt, moisture, salt, oils, grease, fuel, corrosion and other external influences and further media.

The object of the present invention is to specify a lead-through for an electrical conductor which overcomes the aforementioned disadvantages.

The core idea of the lead-through according to the invention is that the electrical conductor is designed to lead an electrical heating device out of the housing in an insulated manner, wherein a temperature gradient is formed over a length of the electrical conductor in order to lower the temperature of the electrical conductor within the lead-through. The temperature gradient is preferably designed in such a way that the electrical conductor has a higher temperature on the side of the lead-through on which it is connected to the electrical heating device than on an opposite side on which it can be contacted with a plug connector. If the temperature of the electrical conductor within the lead-through is lowered, no special materials are needed in order to connect the electrical conductor outside the lead-through to a plug connector. In particular, commercially available connectors can then be used to supply the electrical heating device with power.

The lead-through for an electrical conductor is designed to lead the electrical conductor out of a housing of an exhaust-gas system. The electrical conductor is electrically insulated from other components by the lead-through, and thereby protected against short circuits. The insulated electrical lead-through also provides protection from dirt, moisture and other media. In particular, the ADR requirement can be complied with, which includes a requirement with respect to short circuits.

The electrical heating device can be arranged in an exhaust gas box in order to be led out of the exhaust gas box in a fully insulated manner via the insulated electrical lead-through.

The electrical conductor can preferably be led through a sleeve, wherein insulation is arranged between the sleeve and the electrical conductor. The insulation is designed in particular to space the electrical conductor apart from the sleeve so as to prevent a short circuit between the sleeve and the electrical conductor. The sleeve serves in particular to lead the electrical conductor out of the housing. Advantageously, the sleeve is made from a weldable material so that the sleeve can be welded to the housing. While the sleeve can still have a high temperature, the temperature of the electrical conductor within the sleeve is lowered.

In accordance with a very advantageous refinement of the idea, it can be provided that the insulation contains magnesium oxide or ceramic. Furthermore, for example, glass ceramic can be used. These materials serve as insulation between the current-conducting electrical conductor and the outer casing, formed in particular by the sleeve.

In accordance with one advantageous configuration, it can provided that the electrical conductor is made at least partially from steel or a nickel alloy. The electrical conductor, i.e., the current-conducting components, are preferably designed for the least amount of contact resistance. In particular, a diameter of the current-conducting components can be adapted to a high current load. In this case, in particular, the insulation, i.e., a thickness of the insulation, must not be reduced.

A further advantageous configuration can provide that a diameter of the electrical conductor is adapted to a current load and a thermal conductance of the exhaust gas. In this case, for example, a stainless steel can be used to form the electrical conductor. In another design, the electrical conductor can likewise be made from steel or a nickel alloy, such as Inconel. Stainless steel has the advantage of being less susceptible to corrosion. However, stainless steel disadvantageously has a higher resistivity, which is why it is advantageous to configure the cross-section or the diameter.

For example, a large current flow is advantageous for heating by current load; however, this means that the thermal conductance is better and the electrodes are heated up more strongly due to the exhaust gas Therefore, there should be optimization between cross-section and length of the electrode (or the conductor) in order for there to be as little thermal conductance and as little ohmic heating due to the current load as possible. A greater length can, for example, have a positive effect on the thermal conductance, but be detrimental to the resistance. Likewise, enlarging the diameter can have a positive effect on the heating caused by the current load, but be detrimental to the thermal conductance due to exhaust gas.

In accordance with a very advantageous refinement of the idea, it can be provided that the electrical conductor has a transition point from a steel material to a copper material or from a nickel alloy to a copper material. Such a transition point can be designed such that two different materials meet or are affixed to each other. In order to keep the contact resistance as low as possible, a welded connection produced, for example, by friction welding can be used. For example, in the direction towards the electrical heating device, the electrical conductor can be made from a steel with moderate resistivity in order to withstand the high temperatures at the electrical heating device. This can be achieved, for example, by welding the electrical conductor to the heating device, meaning that they are in direct contact. In order to reduce the temperature development within the lead-through, a transition point that transitions to a material with low resistivity can be provided within the lead-through.

In accordance with one advantageous configuration, it can provided that the electrical conductor has a joint in a region within the sleeve at which a section of the electrical conductor made from a steel material or made from a nickel alloy contacts a section made from a copper material. Such a joint can be designed, for example, as a lap joint, in which case the two sections made from different materials overlap and are therefore affixed to one another. Furthermore, one section can be plugged into the other section and form a type of butt joint. In this case, one conductor can have a moulded tip, so as to be plugged with the tip into the other conductor.

A further advantageous configuration can provide that the temperature of the electrical conductor within the lead-through is lowered to below 180° C., so that the lead-through is able to be connected with a conventional plug connector. In order to achieve such a temperature range, in particular copper or a copper alloy can be used for a section of the electrical conductor.

In accordance with an advantageous refinement of the idea, it can be provided that the sleeve is made from a weldable material, so that the sleeve is able to be welded to the housing. The transition point can thus be mounted at any position on the housing, and in the process, for example, also at any position on an exhaust-gas aftertreatment system.

It can be provided in accordance with one advantageous configuration that an ADR requirement is complied with using the lead-through. In particular, protection against a short circuit between the electrical conductor and the housing out of which the electrical conductor is led is avoided. The ADR requirement prescribes that electrical contacts must be insulated against short circuits.

Further advantageous configurations of the lead-through according to the invention for an electrical conductor also emerge from the exemplary embodiment, which is represented in more detail hereinafter with reference to the figures.

### BRIEF DESCRIPTION OF THE DRAWINGS

FIG. 1 shows a possible embodiment of a lead-through according to the invention;

FIG. 2 shows a possible embodiment of a lead-through according to the invention with a continuous conductor;

FIG. 3 shows a possible embodiment of a lead-through according to the invention with a joint within the conductor; and

FIGS. 4(a)-(c) show further possible embodiments of a lead-through according to the invention with a differently designed joint within the conductor.

### DETAILED DESCRIPTION OF THE DRAWINGS

The illustration in FIG. 1 shows one possible embodiment of the lead-through 1 in a longitudinal section. The section extends along a length of an electrical conductor 2, wherein the electrical conductor 2 is led out of a housing 3 of an exhaust-gas system. In the left-hand part of the illustration, the electrical conductor 2 is therefore connected to an electrical heating device 4 which is led by the electrical conductor 2 out of the housing 3 in an insulated manner. In the right-hand part of the illustration, the electrical conductor 2 is connected to a plug connector 12. The plug connector 12 is in particular a commercially available plug connector that is not adapted to any particularly high temperature requirements. In particular, it suffices to use a plug connector 12 which is designed for a temperature of 200° C. or less, in particular for a temperature of 180° C. This is possible because a temperature gradient is formed over the length of the electrical conductor 2 in order to lower the temperature of the electrical conductor 2 within the lead-through 1. The temperature is lowered in such a way that a high temperature prevailing towards the electrical heating device 4 is lowered over the length of the electrical conductor 2 within the lead-through 1 up to a position outside the housing 3. As a result, the plug connector 12 is not exposed to any high temperatures.

The lead-through 1 can have a sleeve 5 in which the electrical conductor 2 is led. The sleeve can be welded to the housing 3 via weld seams 13. In order to prevent a short circuit between the electrical conductor 2 and the sleeve 5, insulation 6 is provided which leads the electrical conductor 2 within the lead-through 1 spaced apart from the sleeve 5. The insulation 6 is made in particular from a magnesium oxide, a ceramic or a glass ceramic. The ADR requirement can advantageously be complied with if the electrical conductor 2 is protected from short circuits with the housing 3. In particular, a seal can be achieved in the transition region between the sleeve 5 and the plug connection 12 in order to comply with the ADR requirement. This can advantageously be achieved by lowering the temperature as far as the connector 12. Furthermore, the lead-through 1 is preferably designed to be so tight that an ingress of dirt, moisture, salt or other media can be prevented. Furthermore, exhaust gas can be prevented from escaping through the lead-through 1.

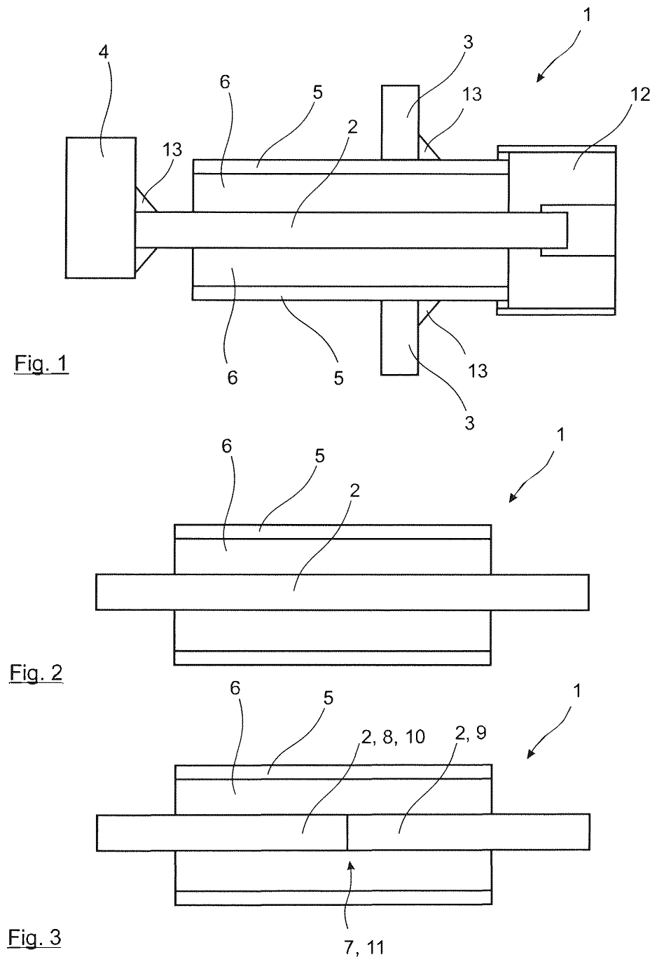

FIG. 2 shows the lead-through 1, consisting of an electrical conductor 2, a sleeve 5 and insulation 6. The sleeve 5 is preferably made from a weldable material. The insulation 6 can be designed as explained above. The electrical conductor 2 is made in particular from pure steel or a nickel alloy, such as Inconel. It is advantageous here if a diameter of the electrical conductor 2 is adapted to the current load and to the thermal conductance through the exhaust gas. In particular, it is advantageous if the current-conducting elements, i.e., in particular the electrical conductor 2, are designed for the least amount of contact resistance.

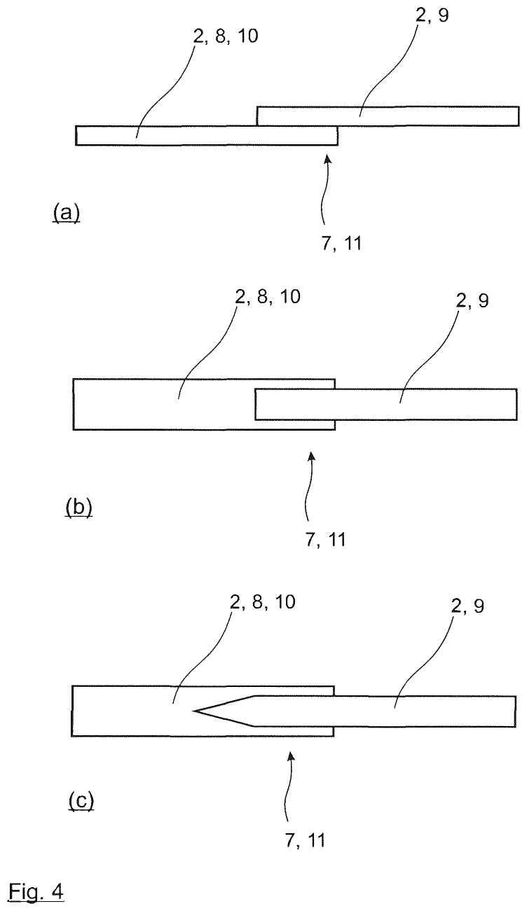

A further design variant of the lead-through 1 can be seen in FIG. 3. The same components have been given the same reference signs, and so they do not need to be discussed in further detail. In contrast to FIG. 2, a transition point 7 is shown here within the lead-through 1, wherein a material transition of the electrical conductor 2 takes place at the transition point 7. Therefore, different sections can be made in which the electrical conductor 2 is made from different materials. For instance, in the left-hand part of the illustration, which is oriented in the direction of the electrical heating device 4, a steel material 8 or a nickel alloy 10 can be used for the electrical conductor 2. In the right-hand part of the illustration, a copper material 9 can be used for the electrical conductor 2. The different materials, i.e., the different sections, come into contact at the transition point 7, which can be designed in particular as a joint 11. The joint 11 can have different configurations, as described in FIG. 4.

Due to the different materials, i.e., due to the sections having different materials, the electrical conductor 2 can particularly advantageously have a temperature gradient within the lead-through, so that the temperature can be lowered away from the electrical heating device 4. This results in a particularly low temperature at a free end of the lead-through 1, so that commercially available plug connectors 12 can be used to contact the electrical conductor 2.

FIG. 4 shows different designs of the joint 11, as can be formed, for example, in the design in FIG. 3. FIG. 4 (a) shows a design as a lap joint, wherein the two sections consisting of a steel material 8 or a nickel alloy 10 and consisting of a copper material 9 overlap. The transition point 7 is therefore shaped as a lap joint, wherein the different sections can be connected to one another by the overlap. FIG. 4 (b) shows a further option, wherein one section of the electrical conductor 2 can be plugged into another section of the electrical conductor 2. Therefore, a type of butt joint can be formed. It is likewise conceivable for the two sections to have different diameters. Furthermore, the two sections can also have identical diameters. This can be achieved in particular by one of the sections having a tip, as shown in FIG. 4 (c). As a result, a joint 11 can be shaped, wherein one of the sections protrudes with the tip into the other section.

The shown examples show possible ways of making a transition from a steel material 8 or a nickel alloy 10 onto a copper material 9. In this case, the diameters of the current-conducting elements, i.e., the sections of the electrical conductor 2, can be adapted to the high current loads. It must simultaneously be ensured that the insulation 6 continues to be formed with a sufficient thickness. It is therefore advantageous to design the current-conducting elements for the least amount of contact resistance.

For the lead-through 1 according to the invention, it is therefore possible to make use of the advantage that an electrical conductor 2 made from a copper material has a low resistivity. This can support or particularly advantageously bring about a temperature reduction within the electrical conductor 2 in the lead-through 1. As a result, the temperature of the electrical conductor 2 can be greatly reduced from the inside to the outside, i.e., from the electrical heating device 4 out of the housing 3, by a suitable selection of materials. Steel with a moderate resistivity is therefore used in particular in the direction towards the electrical heating device 4. This is necessary in particular because high temperatures prevail at the electrical heating device 4. The different materials can be connected to one another within the transition points 7. For example, a lap joint of copper on steel, a plugged connection of copper into steel, a plugged connection of copper into steel with a tip, and a wire transition from steel to copper can be realized. Instead of steel, Inconel can be used, for example. Instead of copper, a copper alloy can also be used, for example.

In a further embodiment (not illustrated), insulation plates can be fitted, which can prevent the insulation 6 from eroding or being removed.

1.-10. (canceled)

11. An apparatus, comprising:
a lead-through (1) for an electrical conductor (2), wherein the electrical conductor (2) is leadable out of a housing (3) of an exhaust-gas system and wherein the electrical conductor (2) is configured to lead a component out of the housing (3) in an insulated manner;
wherein the lead-through (1) is configured such that a temperature gradient is formed over a length of the electrical conductor (2) such that a temperature of the electrical conductor (2) is lowered within the lead-through (1).

12. The apparatus according to claim 11, wherein the lead-through (1) has a sleeve (5) and an insulation (6) and wherein the electrical conductor (2) is leadable through the sleeve (5) such that the insulation (6) is arrangeable between the sleeve (5) and the electrical conductor (2).

13. The apparatus according to claim 12, wherein the insulation (6) contains magnesium oxide or ceramic.

14. The apparatus according to claim 11, wherein the electrical conductor (2) is made at least partially from steel or a nickel alloy.

15. The apparatus according to claim 11, wherein a diameter of the electrical conductor (2) is adapted to a current load and a thermal conductance of exhaust gas from the exhaust-gas system.

16. The apparatus according to claim 11, wherein the electrical conductor (2) has a transition point (7) from a steel material (8) to a copper material (9) or from a nickel alloy (10) to a copper material (9).

17. The apparatus according to claim 12, wherein the sleeve (5) has a region, wherein within the region in the sleeve (5) a joint of the electrical conductor (2) is arrangeable, and wherein at the joint (11) a first section of the electrical conductor (2) made from a steel material (8) or made from a nickel alloy (10) contacts a second section made from a copper material (9).

18. The apparatus according to claim 11, wherein the lead-through (1) is configured such that the temperature of the electrical conductor (2) within the lead-through (1) is lowered to below 180° C.

19. The apparatus according to claim 12, wherein the sleeve (5) is made from a weldable material such that the sleeve (5) is weldable to the housing (3).

20. The apparatus according to claim 11, wherein the lead-through (1) is configured such that the lead-through (1) complies with a requirement of an Agreement concerning the International Carriage of Dangerous Goods by Road (ADR).
